(19) United States
(12) Patent Application Publication
(10) Pub. No.: US 2026/0213620 A1
(43) Pub. Date: Jul. 23, 2026

(54) Shaft Device for an Electric Machine, Electric Machine, and Motor Vehicle

(71) Applicant: Bayerische Motoren Werke AKtiengesellschaft, Muenchen (DE)

(72) Inventor: Johannes MEYER, Karlsfeld (DE)

(21) Appl. No.: 19/140,598

(22) PCT Filed: Jan. 23, 2024
(86) PCT No.: PCT/EP2024/051458

§ 371 Date: Jun. 18, 2025

(30) Foreign Application Priority Data
Jan. 31, 2023 (DE) 10 2023 102 256.3

(51) Int. Cl. H02K 9/193; H02K 7/00; H02K 9/28; H02K 13/00

(52) U.S. Cl. CPC H02K 9/193; H02K 7/003; H02K 9/28; H02K 13/003

(57) ABSTRACT

The disclosure relates to a shaft device for an electric machine, including a slip ring element configured to transmit an excitation current for rotor windings of a rotor of the electric machine can be transmitted and a rotor shaft coupled to the rotor, against which the slip ring element is supported, and which has at least one fluid channel assembly via which fluid can be conducted in the direction of a support body in order to exchange heat with the support body, which has a receiving opening in which the rotor shaft and the slip ring element are rotatably mounted. A seal support of the shaft device is introduced into the receiving opening between the rotor shaft and a wall of the support body and holds at least one seal body between the rotor shaft and the support body, the seal body having a through-opening assembly.

### BACKGROUND AND SUMMARY

The present disclosure relates to a shaft device for an electric machine, comprising a slip ring element, by which excitation current for rotor windings of a rotor of the electric machine can be transmitted, comprising a rotor shaft, which is designed for coupling to the rotor, on which the slip ring element is supported and which has at least one fluid channel arrangement, through which fluid can be conducted in the direction of a supporting body for cooling the supporting body, which has a receiving opening and into the receiving opening of which the rotor shaft and the slip ring element are introduced and/or rotatably mounted. Further aspects of the present disclosure relate to an electric machine comprising such a shaft device and to a motor vehicle.

EP 1 793 459 A1 discloses a slip ring shaft for an electric generator, comprising at least one slip ring for establishing an electrical connection between an electromagnetic coil arranged on a rotor shaft of the electric generator and at least one sliding contact. The slip ring shaft has, at least in some regions, an unwettable surface structure.

An object of the present disclosure is to provide a shaft device of the type mentioned above which enables improved fluid guidance for cooling. Further aspects of the disclosure relate to an electric machine comprising such a shaft device and to a motor vehicle.

This object is achieved by a shaft device having the features of the present disclosure. Advantageous embodiments with expedient developments are also disclosed herein.

A first aspect of the disclosure relates to a shaft device for an electric machine, comprising a slip ring element, by which excitation current for rotor windings of a rotor of the electric machine can be transmitted, comprising a rotor shaft, which is designed for coupling to the rotor, on which the slip ring element is supported and which has at least one fluid channel arrangement, via which fluid can be conducted in the direction of a supporting body in order to exchange heat with the supporting body, which has a receiving opening and into the receiving opening of which the rotor shaft and the slip ring element are introduced and/or rotatably mounted.

According to one or more embodiments disclosed herein, it is provided that a seal carrier of the shaft device is introduced, at least in some regions, into the receiving opening between the rotor shaft and a wall of the supporting body and holds at least one sealing body between the rotor shaft and the supporting body, the sealing body having a through-opening arrangement for conducting the fluid from the fluid channel arrangement toward the supporting body wall. This is advantageous because the sealing body thus assumes, on the one hand, the function of sealing against unwanted egress of the fluid out of the receiving opening and, on the other hand, the function of guiding the fluid in a targeted manner toward the supporting body wall, as a result of which for example heat exchange between the fluid and the supporting body is enabled. The sealing body can impede for example the egress of the fluid in the direction of axial extent of the shaft device and, via the through-opening arrangement, enable the passage of the fluid in the direction of radial extent of the shaft device, as a result of which a targeted application of the fluid to the supporting body can be ensured.

The fluid can preferably be in the form of oil, as a result of which both lubrication and effective temperature control, in particular cooling, of the electric machine is enabled. The supporting body can preferably be designed, at least in some regions, in the shape of a ring, and accordingly, at least in some regions, in the form of a supporting ring, as a result of which uniform support around the circumference is enabled. The supporting body can generally serve to cool the fluid, that is to say it can generally serve for example as a cooling element. It is also conceivable in principle, however, that the supporting body can also serve, for example during a cold start of the electric machine, for heating, that is to say it can serve as a heating element, in order to effect for example fast warming of the fluid, for example in cold ambient temperatures. The fluid can thus be guided overall via the fluid channel arrangement, through the through-opening arrangement, and toward the supporting body wall, in order to effect heat exchange between the fluid and the supporting body.

The wall of the supporting body can preferably be designed in the form of a hollow-cylindrical wall region of the supporting body and surround the receiving opening.

The seal carrier can hold the sealing body, preferably in the direction of radial extent of the shaft device, between the rotor shaft and the supporting body, such that the inner circumference of the supporting body can be uniformly wetted with the fluid during operation of the electric machine, in particular when the rotor shaft is rotating. This allows for particularly effective heat transfer between the fluid and the supporting body.

The disclosure is based on the knowledge that rotor shafts of electric machines, in particular of electrically excited synchronous machines, are often designed in two parts in order for current-carrying conductors to be guided underneath respective bearings and underneath radial seals. The two-part design of rotor shafts leads, however, to low rigidity in comparison with single-part rotor shafts. In addition, a corresponding joint can cause a deterioration in concentricity at respective bearing seats of the rotor shaft parts, which can lead in turn to unwanted, increased bearing forces as well as acoustic abnormalities.

In a single-part design of the rotor shaft, current-carrying conductors can be guided for example along two longitudinal grooves on the rotor shaft toward respective windings and can be connected to these windings. If potting with resin, in particular epoxy resin, for example by vacuum potting, takes place during production of such a shaft device and/or electric machine, sealing in the region of these longitudinal grooves is associated with increased effort, wherein manual rework may often be required to remove resin from fluid-guiding openings.

Aspects of the present disclosure enable a single-part design of the rotor shaft along with, at the same time, sufficient heat exchange between the fluid and the supporting body, wherein costly rework can be avoided. The receiving opening, in which the rotor shaft and the supporting body are introduced, can preferably be designed in the form of a hub, on the one hand, for the rotor shaft and, on the other hand, also for the slip ring element.

In an advantageous development of the present disclosure, the sealing body is designed in the form of a band element surrounding the circumference of the rotor shaft. This is advantageous because, due to the design as a band element, at least one through-opening of the through-opening arrangement can be designed to be particularly large, as a result of which large amounts of the fluid can be guided through this through-opening. The term band element can be a sealing ring with a for example substantially rectangular cross section. Such a sealing ring designed in the form of a band element can have for example sealing lips, due to which a slight geometrical deviation from a pure cross-sectional shape can be present, to name but one example. However, despite such sealing lips, an at least substantially rectangular cross section can be present.

In another advantageous development of the present disclosure, the through-opening arrangement has through-openings, via which the fluid can be conducted from the fluid channel arrangement toward the supporting body wall. In an advantageous manner, the through-opening arrangement can thus have multiple, for example six, through-openings, as a result of which a particularly large amount of the fluid can be transported to the supporting body. A particularly uniform distribution of the fluid can be achieved when the through-openings are distributed uniformly in the circumferential direction of the sealing body, of the rotor shaft and/or of the shaft device.

In another advantageous development of the present disclosure, at least one of the through-openings is designed in the form of an elongated hole. It is advantageous that the design in the form of an elongated hole enables greater flexibility when dimensioning the sealing body. Preferably, a main direction of extent of the elongated hole can be oriented in the circumferential direction or at least substantially in the circumferential direction of the sealing body and/or of the rotor shaft and/or of the shaft device. The term oriented “substantially in the circumferential direction” can be understood in this context to mean that the main direction of extent can be oriented primarily in the circumferential direction, and is thus oriented correspondingly less toward the direction of axial extent of the sealing body and/or of the rotor shaft and/or of the shaft device.

In another advantageous development of the present disclosure, at least one of the through-openings is bounded by at least one sealing lip. This leads to improved sealing and impedes unwanted egress of the fluid.

In another advantageous development of the present disclosure, the sealing body is supported on the rotor shaft and/or on the supporting body via the at least one sealing lip. This results in particularly advantageous sealing directly on the rotor shaft and/or on the supporting body. Advantageously, the sealing body can have two sealing lips, wherein a first sealing lip (lower or inner sealing lip) of the two sealing lips can abut the rotor shaft and a second sealing lip (upper or outer sealing lip) of the two sealing lips can abut the supporting body.

In another advantageous development of the present disclosure, the fluid channel arrangement comprises at least one radial fluid channel, which is oriented in the direction of radial extent of the rotor shaft and has a radial fluid channel cross-section, which overlaps, at least in some regions, with one of the through-openings in the direction of a radial fluid channel central axis, in particular when the rotor shaft is rotating during intended use of the electric machine. This is advantageous because it can ensure a continuous application of the fluid to the supporting body uniform when the rotor shaft is rotating.

In another advantageous development of the present disclosure, at least one sealing ring element is arranged between the slip ring element and the supporting body wall. This enables a gap between the slip ring element and the supporting body wall to be sealed in an advantageous manner. The sealing ring element can be designed for example in the form of a radial sealing ring.

A second aspect of the present disclosure relates to an electric machine comprising a shaft device according to the first aspect of the present disclosure. This electric machine can preferably be designed in the form of an electrically excited synchronous machine—EESM for short—wherein improved fluid guidance and cooling are enabled.

A third aspect of the present disclosure relates to a motor vehicle comprising a shaft device according to the first aspect of the present disclosure and/or comprising an electric machine according to the second aspect of the present disclosure. Improved cooling and fluid guidance are realized in this motor vehicle.

The preferred embodiments and their advantages presented with respect to one of the aspects apply correspondingly to each of the other aspects of the present disclosure and vice versa.

The features and combinations of features mentioned in the description above and the features and combinations of features mentioned in the description of the figures below and/or shown in the figures alone can be used not only in the combination indicated, but also in other combinations or alone without departing from the scope of the present disclosure.

Additional advantages, features, and details of the present disclosure can be found in the following description of preferred embodiments and based on the drawings.

The present disclosure will be explained again hereinbelow based on one or more exemplary embodiments.

### BRIEF DESCRIPTION OF THE DRAWINGS

FIG. 1 shows a schematic sectional representation of a subregion of a shaft device which is assigned to an electric machine, which is represented in highly abstracted form, wherein the electric machine is designed in the form of a drive machine of a motor vehicle, which is likewise represented in highly abstracted form; and

FIG. 2 shows a perspective sectional representation of the subregion of the shaft device shown in FIG. 1.

### DETAILED DESCRIPTION OF THE DRAWINGS

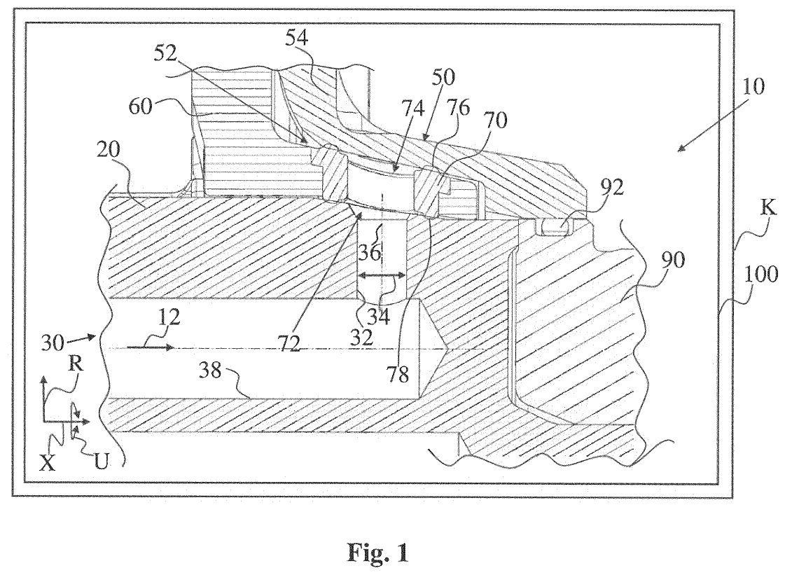

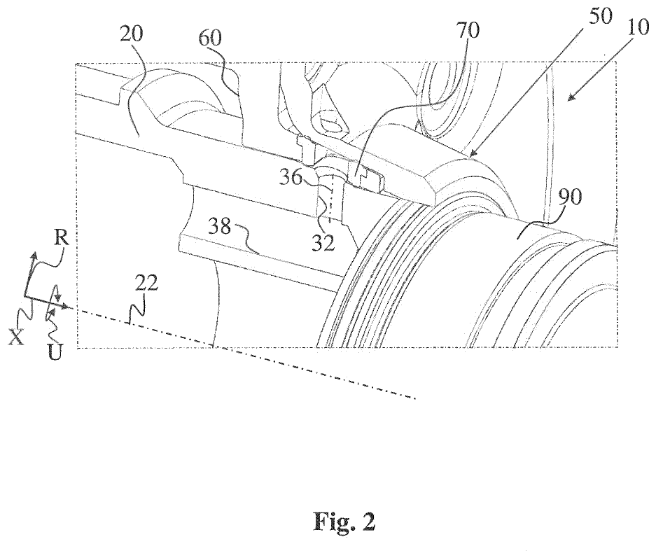

FIG. 1 shows an abstracted representation of a motor vehicle K, which has an electric machine 100, which serves as the drive motor of the motor vehicle K. The electric machine 100, which is designed by way of example in the form of an electrically excited synchronous machine—EESM for short—comprises a shaft device 10, which is shown partially and in a schematic sectional representation in FIG. 1 and partially and in a perspective sectional representation in FIG. 2.

The shaft device 10 has a slip ring element 90, which can also be referred to as a slip ring module. Excitation current for rotor windings for a rotor of the electric machine 100 can be transmitted via the slip ring element 90. The shaft device 10 also comprises a rotor shaft 20 (shown only partially), which is coupled to the rotor and on which the slip ring element 90 is supported and which has a fluid channel arrangement 30. The rotor shaft has a central axis, along which an axis of rotation 22 (shown only in FIG. 2) runs. The axis of rotation 22 extends parallel to a direction of axial extent X of the shaft device 10.

Via the fluid channel arrangement 30, fluid 12, such as oil, can be brought into contact with a supporting body 50, which has a receiving opening 52, in order to exchange heat, namely for cooling the fluid 12. The fluid 12 can be conducted via the fluid channel arrangement 30 toward the supporting body 50, in the receiving opening 52 of which the rotor shaft 20 and the slip ring element 90 are introduced and rotatably mounted. The supporting body 50 can be designed, as can be seen in FIG. 2, at least in some regions or in its entirety in the form of a supporting ring.

A seal carrier 60 of the shaft device 10 is introduced, in some regions, into the receiving opening 52 between the rotor shaft 20 and a wall 54 of the supporting body 50. In the direction of radial extent R of the shaft device 10, a sealing body 70 is held between the rotor shaft 20 and the supporting body 50 by the seal carrier 60, the sealing body having a through-opening arrangement 72 for conducting the fluid 12 from the fluid channel arrangement 30 toward the supporting body wall 54. A circumferential direction U of the rotor shaft 20 and of the sealing body 70 is illustrated in FIG. 1 by a curved double arrow, which extends perpendicularly to, and around, the direction of axial extent X.

The sealing body 70 is designed in the form of a band element surrounding the circumference of the rotor shaft 20, and the through-opening arrangement 72 has multiple through-openings 74, via which the fluid 12 can be conducted from the fluid channel arrangement 30 toward the supporting body wall 54. In FIG. 1 and FIG. 2, only one of the through-openings 74 can be seen, but the sealing body 70, or rather its through-opening arrangement 72, has, by way of example, six through-openings 74 distributed uniformly over the circumference of the sealing body 70, each of which is designed in the form of an elongated hole. The design with six through-openings 74 has proven to be particularly suitable for achieving a high-level cooling effect while simultaneously providing the sealing ring 70 with good durability.

Each of the through-openings 74 is bounded by two sealing lips, namely one (upper) sealing lip 76, which is the outer one in the direction of radial extent R, and one (lower) sealing lip 78, which is the inner one in the direction of radial extent R. The outer sealing lip 76 abuts the supporting body wall 54, forming a first sealing seat, whereas the inner sealing lip 78 abuts the rotor shaft 20.

The respective sealing lips 76, 78 thus provide support, that is to say sealing abutment, for the sealing body 70 on the rotor shaft 20, on the one side, and the supporting body 50, on the other side. The sealing body 70 is deformed in the shape of a cone due to being supported on the rotor shaft 20.

The fluid channel arrangement 30 comprises an axial fluid channel 38, which is oriented in the direction of axial extent X and is connected to at least one radial fluid channel 32, which is oriented in the direction of radial extent R of the rotor shaft 20. Preferably six radial fluid channels 32 can be provided. Preferably six axial fluid channels 38 can also be provided, wherein each of the axial fluid channels 38 can be connected to a respective one of the radial fluid channels 32. The fluid 12 can therefore flow first through the axial fluid channel 38 and then into the radial fluid channel 32 during operation of the electric machine 100. When the rotor shaft 20 is rotating about the axis of rotation 22, the fluid 12 can be fed through the radial fluid channel 32 and thus, in the direction of radial extent R, to the supporting body wall 54 with the aid of centrifugal force. When the supporting body wall 54 is wetted with the fluid 12, the fluid 12 can be cooled. The radial fluid channel 32 has a radial fluid channel cross section 34, which intermittently overlaps, at least in some regions and at least when the rotor shaft 20 is rotating, with one of the through-openings 74 in the direction of a radial fluid channel central axis 36.

To prevent unwanted egress of the fluid 12 in the direction of axial extent X along the slip ring element 90, a sealing ring element 92 designed in the form of a radial sealing ring is arranged between the slip ring element 90 and the supporting body wall 54.

In summary, in the present variant of the shaft device 10, the supporting ring (supporting body 50) is provided with the receiving opening 52, which serves as a hub and is sealed all the way round on the slip ring module (slip ring element 90) by an O-ring as the sealing ring element 92. To seal the six radial oil bores (radial fluid channels 32), the sealing body 70 is used as a molded sealing element, which provides, between the rotor shaft 20 and the hub of the supporting ring, six elongated holes (through-opening arrangement 72 comprising a total of six through-openings 74 distributed uniformly in the circumferential direction U) with the respective sealing lips 76, 78. This establishes the connection between the oil bore of the rotor shaft 20 and a double bore of the supporting ring. The elongated holes reduce the required angular accuracy for the manufacturing/installation of the supporting ring and the rotor shaft 20. Pressing of the sealing lips 76, 78 can be achieved by forming a cone on the rotor shaft 20 when the sealing element (sealing body 70) is slid axially (parallel to the direction of axial extent X) to the correct position, as shown in FIG. 1.

### LIST OF REFERENCE SIGNS

10 Shaft device
12 Fluid
20 Rotor shaft
22 Axis of rotation
30 Fluid channel arrangement
32 Radial fluid channel
34 Radial fluid channel cross section
36 Radial fluid channel central axis
38 Axial fluid channel
50 Supporting body
52 Receiving opening
54 Supporting body wall
60 Seal carrier
70 Sealing body
72 Through-opening arrangement
74 Through-opening
76 Upper sealing lip (radially outer sealing lip)
78 Lower sealing lip (radially inner sealing lip)
90 Slip ring element
92 Sealing ring element
100 Electric machine
K Motor vehicle
R Direction of radial extent
U Circumferential direction
X Direction of axial extent

1-10. (canceled)

11. A shaft device for an electric machine, comprising:
a slip ring element configured to transmit an excitation current for rotor windings of a rotor of the electric machine;
a rotor shaft, configured to be coupled to the rotor and support the slip ring element, the rotor shaft having at least one fluid channel arrangement via which fluid is configured to be conducted in a direction of a supporting body to exchange heat with the supporting body, the supporting body having a receiving opening into which the rotor shaft and the slip ring element are rotatably mounted; and
a seal carrier of the shaft device introduced, at least in some regions, into the receiving opening between the rotor shaft and a supporting body wall, the seal carrier holding at least one sealing body between the rotor shaft and the supporting body, the sealing body having a through-opening arrangement configured to conduct the fluid from the fluid channel arrangement toward the supporting body wall.

12. The shaft device according to claim 11, wherein:
the sealing body comprises a band element surrounding a circumference of the rotor shaft.

13. The shaft device according to claim 11, wherein:
the through-opening arrangement comprises through-openings, via which the fluid is configured to be conducted from the fluid channel arrangement toward the supporting body wall.

14. The shaft device according to claim 13, wherein:
at least one of the through-openings comprises an elongated hole.

15. The shaft device according to claim 13, wherein:
at least one of the through-openings is bounded by at least one sealing lip.

16. The shaft device according to claim 15, wherein:
the sealing body is supported on the rotor shaft and/or on the supporting body via the at least one sealing lip.

17. The shaft device according to claim 13, wherein:
the fluid channel arrangement comprises at least one radial fluid channel oriented in a direction of radial extent of the rotor shaft and has a radial fluid channel cross section, which overlaps, at least in some regions, with one of the through-openings in a direction of a radial fluid channel central axis.

18. The shaft device according to claim 11, wherein:
at least one sealing ring element is arranged between the slip ring element and the supporting body wall.

19. An electric machine comprising a shaft device comprising:
a slip ring element configured to transmit an excitation current for rotor windings of a rotor of the electric machine;
a rotor shaft, configured to be coupled to the rotor and support the slip ring element, the rotor shaft having at least one fluid channel arrangement via which fluid is configured to be conducted in a direction of a supporting body to exchange heat with the supporting body, the supporting body having a receiving opening into which the rotor shaft and the slip ring element are rotatably mounted; and
a seal carrier of the shaft device introduced, at least in some regions, into the receiving opening between the rotor shaft and a supporting body wall, the seal carrier holding at least one sealing body between the rotor shaft and the supporting body, the sealing body having a through-opening arrangement configured to conduct the fluid from the fluid channel arrangement toward the supporting body wall.

20. The electric machine according to claim 19, wherein:
the sealing body comprises a band element surrounding a circumference of the rotor shaft.

21. The electric machine according to claim 19, wherein:
the through-opening arrangement comprises through-openings, via which the fluid is configured to be conducted from the fluid channel arrangement toward the supporting body wall.

22. The electric machine according to claim 21, wherein:
at least one of the through-openings comprises an elongated hole.

23. The electric machine according to claim 21, wherein:
at least one of the through-openings is bounded by at least one sealing lip.

24. The electric machine according to claim 23, wherein:
the sealing body is supported on the rotor shaft and/or on the supporting body via the at least one sealing lip.

25. The electric machine according to claim 21, wherein:
the fluid channel arrangement comprises at least one radial fluid channel oriented in a direction of radial extent of the rotor shaft and has a radial fluid channel cross section, which overlaps, at least in some regions, with one of the through-openings in a direction of a radial fluid channel central axis.

26. The electric machine according to claim 19, wherein:
at least one sealing ring element is arranged between the slip ring element and the supporting body wall.

27. A motor vehicle comprising at least one electric machine comprising a shaft device comprising:
a slip ring element configured to transmit an excitation current for rotor windings of a rotor of the electric machine;
a rotor shaft, configured to be coupled to the rotor and support the slip ring element, the rotor shaft having at least one fluid channel arrangement via which fluid is configured to be conducted in a direction of a supporting body to exchange heat with the supporting body, the supporting body having a receiving opening into which the rotor shaft and the slip ring element are rotatably mounted; and
a seal carrier of the shaft device introduced, at least in some regions, into the receiving opening between the rotor shaft and a supporting body wall, the seal carrier holding at least one sealing body between the rotor shaft and the supporting body, the sealing body having a through-opening arrangement configured to conduct the fluid from the fluid channel arrangement toward the supporting body wall.

28. The motor vehicle according to claim 27, wherein:
the sealing body comprises a band element surrounding a circumference of the rotor shaft.

29. The motor vehicle according to claim 27, wherein:
the through-opening arrangement comprises through-openings, via which the fluid is configured to be conducted from the fluid channel arrangement toward the supporting body wall.

30. The motor vehicle according to claim 29, wherein:
at least one of the through-openings comprises an elongated hole and/or is bounded by at least one sealing lip.
